(19) United States
(12) Patent Application Publication
(10) Pub. No.: US 2003/0093211 A1
(43) Pub. Date: May 15, 2003

(54) Method of engine surge discrimination

(76) Inventor: Raymond D. Zagranski, Somers, CT (US)

Correspondence Address: CUMMINGS AND LOCKWOOD, GRANITE SQUARE, 700 STATE STREET, P O BOX 1960, NEW HAVEN, CT, 06509-1960, US

(21) Appl. No.: 10/194,811

(22) Filed: Jul. 12, 2002

Related U.S. Application Data
(60) Provisional application No. 60/335,498, filed on Nov. 15, 2001.

(51) Int. Cl. G06F 19/00

(52) U.S. Cl. 701/100

(57) ABSTRACT

A method of discriminating between spurious and genuine surges in a gas turbine engine is disclosed which includes the steps of receiving an engine speed signal over a global engine surge investigation region having a plurality of temporal regions in which engine surge events can occur, identifying a specific temporal region in which an engine surge event occurs, incrementing a surge counter corresponding to the temporal region in which the engine surge event occurred by a magnitude of two, identifying the temporal regions in which no engine surge event occurred, decrementing a surge counter corresponding to each temporal region in which no engine surge event occurred by a magnitude of one; and enabling a surge avoidance flag when the magnitude of the surge counter has reached a predetermined value.

### CROSS-REFERENCE TO RELATED APPLICATIONS

The subject application claims the benefit of priority to U.S. Provisional Patent Application Serial No. 60/335,498, which was filed on Nov. 15, 2001, the disclosure of which is incorporated herein by reference in its entirety.

### BACKGROUND OF THE INVENTION

1. Field of the Invention

The subject invention relates to a control system for use with aircraft gas turbine engines, and more particularly to, a method of discriminating between spurious engine surges caused by disturbances to the inlet gas stream and genuine engine surges caused by the deterioration of the core engine or the malfunction of a critical engine component.

2. Background of the Related Art

The occurrence of a surge event in a gas turbine engine is often a precursor to a stall condition. State-of-the-art adaptive digital control systems for helicopter gas turbine engines are configured to modify baseline engine acceleration schedules following an engine surge event in an effort to compensate for and avoid future engine surges. However, these modifications are not permanently stored in computer memory because the surge event may have been spurious rather than genuine. Instead, they are stored in the volatile computer memory (RAM).

Spurious engine surges can result from the ingestion of munitions gases, rocket exhaust gases or engine exhaust gases causing a distortion in the inlet air flow to the engine. Genuine engine surges, on the other hand, often result from the deterioration of the core engine or malfunction of an engine component such as an inlet guide vane or bleed valve, and require repair or removal of the engine.

Often, after an initial engine surge event and subsequent modification of the baseline acceleration schedules of the engine, the remainder of the flight is without incident. However, since the acceleration schedule modifications are not stored in the permanent computer memory, if the initial surge event was indeed genuine, the engine will surge again on subsequent flights, and the engine performance will remain deteriorated. Under such circumstances, the engine would be removed from service.

It would be beneficial therefore, to provide a method of discriminating between spurious engine surges caused by disturbances to the inlet gas stream and genuine or true engine surges caused by the deterioration of the core engine or malfunction of critical engine components. Such a method would allow surge avoidance modifications to be permanently stored in non-volatile computer memory for subsequent application. The engine would remain in service until the next scheduled maintenance stop, thereby minimizing aircraft downtime.

### SUMMARY OF THE INVENTION

The subject invention is directed to a new and useful method of discriminating between spurious and genuine surges in a gas turbine engine of a helicopter. The method includes the steps of receiving a turbine speed signal over a global engine surge investigation region (typically from idle to maximum turbine speed) having a plurality of temporal regions in which engine surge events can occur, identifying a specific temporal region in which an engine surge event occurs, and incrementing a surge counter corresponding to the specific temporal region in which the engine surge event occurred.

The method further includes the steps of identifying the specific temporal regions of the global engine surge investigation region (i.e., idle to max speed) in which no engine surge event occurred, and decrementing a surge counter corresponding to each specific temporal region in which no engine surge event occurred. The method also includes enabling a surge avoidance flag when a surge counter corresponding to one of the temporal region reaches a predetermined value, and the step of modifying a baseline engine acceleration schedule in response to an engine surge avoidance flag.

Preferably, the step of incrementing a surge counter corresponding to a specific temporal region in which the engine surge event occurred includes incrementing the particular surge counter by a magnitude of two. Preferably, the step of decrementing a surge counter corresponding to each specific temporal region in which no engine surge event occurred includes decrementing the particular surge counter by a magnitude of one.

Preferably, the step of enabling a surge avoidance flag includes enabling a surge avoidance flag when the magnitude of a surge counter corresponding to one of the regions reaches a value that is greater than or equal to five. However, it is envisioned that this predetermined value may vary depending upon the engine application with which the subject methodology is employed or the operating environment in which the aircraft is engaged. Preferably, the method also includes the step of resetting each of the surge counters when power to an engine control unit goes to zero. Preferably, the method further includes the step of providing a global surge investigation region from idle to maximum turbine speed with five temporal regions in which engine surge events can occur. It is envisioned however, that the number of temporal regions in which surge events can occur can vary depending upon the engine application with which the subject methodology is employed or the operating environment in which the aircraft is engaged.

These and other aspects of the method of the subject invention will become more readily apparent to those having ordinary skill in the art from the following detailed description of the invention taken in conjunction with the drawings described herein below.

### BRIEF DESCRIPTION OF THE DRAWINGS

So that those having ordinary skill in the art to which the unique method of the subject invention appertains will more readily understand how to make and use the same, reference may be had to the drawings wherein:

FIG. 1 is a schematic representation of the engine surge discrimintion logic configured in accordance with a preferred embodiment of the subject invention which communicates with an engine speed sensor and baseline acceleration schedules which can be modified to avoid future engine surges.

Further features of the control logic of the subject invention will become more apparent from the detailed description of preferred embodiments of the invention that follows.

### DETAILED DESCRIPTION OF PREFFERRED EMBODIMENTS

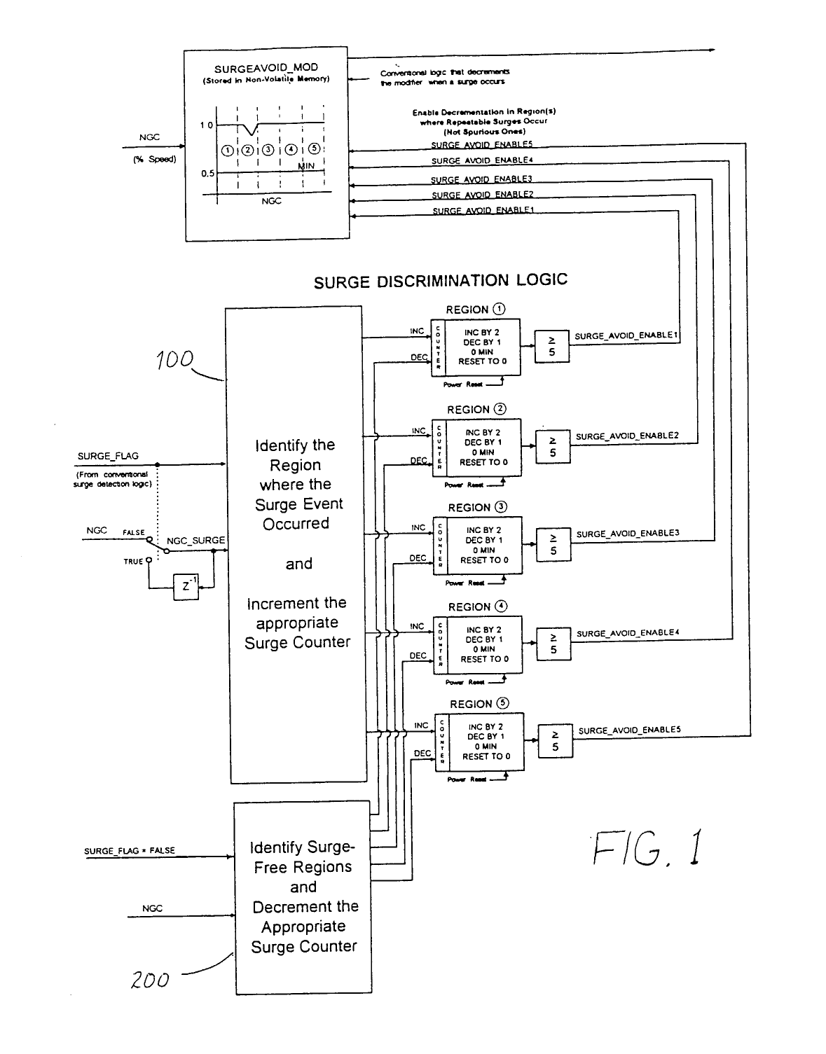

Referring now to FIG. 1, there is disclosed a schematic diagram depicting the logic flow for discriminating between spurious and genuine surges in a gas turbine engine of a helicopter. Spurious engine surges can result from a distortion in the inlet air flow to the engine, caused by the ingestion of munitions gases, rocket exhaust gases or engine exhaust gases. Genuine engine surges often result from the deterioration of the core engine or the malfunction of an engine component such as an inlet guide vane or bleed valve.

As illustrated in FIG. 1, the control logic utilizes input from, among other sources, an engine sensor in the form of an NGC speed signal which is evaluated over a predefined investigation region (typically from idle to maximum turbine speed) period consisting of a plurality of temporal regions in which engine surge events can occur. In accordance with the subject disclosure, there are five temporal regions within the global predefined investigation region. It is envisioned however, that the extent of the global engine surge investigation region and the number of temporal regions can vary depending upon the type of engine with which the subject control logic is employed and the operating environment of the helicopter with which the engine is associated.

When the engine is operating within the global predefined investigation region, the system evaluates the NGC speed signal received from an engine sensor to identify specific regions in which a surge event has occurred, as well as the surge-free regions in which no surge event has occurred. The goal of the methodology is to identify specific regions of the NGC signal in which repeatable engine surges occur, as it is these surge events that are likely to be genuine rather than spurious.

The control logic includes a processing block 100 that is adapted and configured to identify regions of the NGC signal where surge events have occurred, and a processing block 200 that is adapted and configured to identify surge-free regions of the NGC signal. The NGC_SURGE signal received by processing block 100 results from a gate triggered by SURGE_FLAG signals from conventional surge detection logic. When the SURGE_FLAG triggers the gate to the TRUE position, the last value is held. In addition to the NGC signal, processing block 200 receives a signal indicating that the SURGE_FLAG is FALSE.

Five surge counters, one for each of the five-temporal regions of the investigation period, are cooperatively associated with processing blocks 100 and 200. Processing block 100 is configured to increment a surge counter corresponding to a region in which a surge has occurred by a value of two, while processing block 200 is configured to decrement a surge counter corresponding to a surge-free region by a value of one.

When one of the five surge counters attains a value that is greater than or equal to five, a surge avoidance signal SURGE_AVOID_ENABLE is transmitted. This signal is then used to modify the baseline engine fuel flow, inlet guide vane and/or bleed valve schedules. The surge avoidance modification SURGEAVOID_MOD is then retained in the non-volatile memory of an on-board computer for future reference and use. The system is configured to reset each of the five surge counters utilized with the control logic to zero when power to an engine control unit goes to zero.

In the example presented in FIG. 1, multiple surge events had occurred in region (2) during a previous investigation period (i.e., in a previous flight or earlier in the current flight). As a result, the SURGE_AVOID_MOD shows a decrement from its baseline value of 1.

Although the system and method of the subject invention has been described with respect to preferred embodiments, those skilled in the art will readily appreciate that changes and modifications may be made thereto without departing from the spirit and scope of the present invention as defined by the appended claims.

What is claimed is:

1. A method of discriminating between spurious and genuine surges in a gas turbine engine comprising the steps of:
a) receiving an engine speed, signal over a global engine surge investigation region having a plurality of temporal regions in which engine surge events can occur;
b) identifying a specific temporal region of the global engine surge investigation region in which an engine surge event occurs;
c) incrementing a surge counter corresponding to the specific temporal region of the global engine surge investigation region in which the engine surge event occurred;
d) identifying the specific temporal regions of the global engine surge investigation region in which no engine surge event occurred;
e) decrementing a surge counter corresponding to each specific temporal region of the global engine surge investigation region in which no engine surge event occurred; and
f) enabling a surge avoidance flag when a surge counter corresponding to one of the temporal regions reaches a predetermined value.

2. A method according to claim 1, wherein the step of incrementing a surge counter corresponding to a temporal region of the global engine surge investigation region in which the engine surge event occurred comprises incrementing said surge counter by a magnitude of two.

3. A method according to claim 1, wherein the step of decrementing a surge counter corresponding to each temporal region of the global engine surge investigation region in which no engine surge event occurred comprises decrementing said surge counter by a magnitude of one.

4. A method according to claim 1, wherein the step of enabling a surge avoidance flag includes enabling a surge avoidance flag when the magnitude of a surge counter is at least equal to five.

5. A method according to claim 1, further comprising the step of resetting each of the surge counters when power to an engine control unit goes to zero.

6. A method according to claim 1, further comprising the step of providing a global surge investigation region with five temporal regions in which engine surge events can occur.

7. A method according to claim 1, further comprising the step of modifying baseline engine control schedules in response to an engine surge avoidance flag.

8. A method according to claim 7, further comprising the step of storing a modification to baseline engine control schedules in non-volatile memory for subsequent application.

9. A method of discriminating between spurious and genuine surges in a gas turbine engine comprising the steps of:
a) receiving an engine speed signal over a global engine surge investigation region having a plurality of temporal regions in which engine surge events can occur;
b) identifying a specific temporal region of the global engine surge investigation region in which an engine surge event occurs;
c) incrementing a surge counter corresponding to the specific temporal region of the global engine surge investigation region in which the engine surge event occurred by a first magnitude;
d) identifying the specific temporal regions of the global engine surge investigation region in which no engine surge event occurred;
e) decrementing a surge counter corresponding to each temporal region of the global engine surge investigation region in which no engine surge event occurred by a second magnitude that is less than the first magnitude; and
f) enabling a surge avoidance flag when the magnitude of a surge counter corresponding to one of the temporal regions reaches a predetermined value.

10. A method according to claim 9, wherein the step of incrementing a surge counter corresponding to a temporal region of the global engine surge investigation region in which the engine surge event occurred comprises incrementing said surge counter by a magnitude of two.

11. A method according to claim 9, wherein the step of decrementing a surge counter corresponding to each temporal region of the global engine surge investigation region in which no engine surge event occurred comprises decrementing said surge counter by a magnitude of one.

12. A method according to claim 9, wherein the step of enabling a surge avoidance flag includes enabling a surge avoidance flag when the magnitude of a surge counter has reached a value that is at least equal to five.

13. A method according to claim 9, further comprising the step of resetting each of the surge counters when power to an engine control unit goes to zero.

14. A method according to claim 9, further comprising the step of providing a global surge investigation region with five temporal regions in which engine surge events can occur.

15. A method according to claim 9, further comprising the step of modifying baseline engine control schedules in response to an engine surge avoidance flag.

16. A method according to claim 15, further comprising the step of storing a modification to baseline engine control schedules in non-volatile memory for subsequent application.

17. A method of discriminating between spurious and genuine surges in a gas turbine engine comprising the steps of:
a) receiving an engine speed signal over a global engine surge investigation region having a plurality of temporal regions in which engine surge events can occur;
b) identifying a specific temporal region of the global engine surge investigation region in which an engine surge event occurs;
c) incrementing a surge counter corresponding to the temporal region of the global engine surge investigation region in which the engine surge event occurred by a magnitude of two;
d) identifying the temporal regions of the global engine surge investigation region in which no engine surge event occurred;
e) decrementing a surge counter corresponding to each temporal region of the global engine surge investigation region in which no engine surge event occurred by a magnitude of one; and
f) enabling a surge avoidance flag when the magnitude of the surge counter corresponding to one of the temporal regions has reached a predetermined value.

18. A method according to claim 17, wherein the step of enabling a surge avoidance flag includes enabling a surge avoidance flag when the magnitude of a surge counter has reached a value that is at least equal to five.

19. A method according to claim 17, further comprising the step of resetting each of the surge counters when power to an engine control unit goes to zero.

20. A method according to claim 17, further comprising the step of providing a global surge investigation region with five temporal regions in which engine surge events can occur.

21. A method according to claim 17, further comprising the step of modifying baseline engine control schedules in response to an engine surge avoidance flag.

22. A method according to claim 21, further comprising the step of storing a modification to baseline engine control schedules in non-volatile memory for subsequent application.
